(19) United States
(12) Patent Application Publication
(10) Pub. No.: US 2011/0207000 A1
(43) Pub. Date: Aug. 25, 2011

(54) Nitrile additive for non-aqueous electrolyte rechargeable electrochemical cells

(76) Inventors: T. Richard Jow, Potomac, MD (US); Shengshui Zhang, Olney, MD (US); Conrad Xu, North Potomac, MD (US)

(21) Appl. No.: 11/518,745

(22) Filed: Sep. 7, 2006

(51) Int. Cl. H01M 10/056

(52) U.S. Cl. 429/343; 429/188; 429/341; 429/200

(57) ABSTRACT

An electrochemical system is provided by the present invention which includes a positive electrode; a negative electrode; an electrolyte containing a lithium salt dissolved in a non-aqueous solvent; and a nitrile component in the electrolyte. A preferred nitrile component is an aromatic nitrile. Also described is a process for inhibiting electrolyte decomposition wherein an initial cycle is performed on an inventive electrochemical system such that a solid-electrolyte interphase forms on the anode, inhibiting electrolyte decomposition.

### GOVERNMENT INTEREST

The invention described herein may be manufactured, used, and licensed by or for the United States Government.

### FIELD OF THE INVENTION

The invention relates to electrochemical cells and compositions of electrolytes for use therein. The invention further relates to a process of inhibiting decomposition of electrolyte and forming a protective surface layer on a component of an electrochemical cell.

### BACKGROUND OF THE INVENTION

High voltage and high energy density rechargeable (or secondary) lithium batteries based on non-aqueous electrolytes are widely used in portable electronic devices such as camcorders, notebook computers, and cell phones. Cathodes of this type of battery employ lithiated transition metal oxides such as LiCoO₂, LiNiO₂, LiMn₂O₄. A number of compositions are used as anode materials for rechargeable lithium batteries, including lithium metal, lithium alloys, and carbonaceous materials. Generally, lithium batteries use Li metal as an anode. In contrast, lithium-ion (Li-ion) batteries include carbonaceous materials in the anode. In a lithium-ion battery, lithium ions are intercalated into and de-intercalated out of carbonaceous materials during charge and discharge processes, respectively. One advantage of carbon anodes is that they do not have the problems of dendrite growth on the lithium metal which causes shorting of the cell.

Due to the high potential of the cathode material (up to 4.3 V vs. Li/Li⁺) and the low potential of the carbonaceous anode material (0.01V vs. Li/Li⁺) in a fully charged lithium-ion cell, the choice of the electrolyte solvent system is limited. Since ester solvents, in particular, cyclic carbonate solvents, have high oxidative stability toward typically used lithiated cathode materials and good kinetic stability toward carbonaceous anode materials, they are generally used in Li-ion cell electrolytes. To achieve optimum cell performance, such as high rate capability and long cycle life, solvent systems containing a mixture of one or more cyclic esters having high dielectric constant solvent and one or more linear esters having low viscosity solvent are typically used in commercial Li-ion cells. However, the selection of particular solvents depends greatly on the type of carbonaceous materials used in the anode for Li-ion cells. When amorphous or graphitization retardant carbon material is used as anode material, a cyclic ester such as propylene carbonate (PC) is the main solvent. PC has such advantages as good oxidative stability, thermal stability, and lower melting point compared to another cyclic ester, ethylene carbonate (EC). Therefore, it is desirable to utilize PC in the electrolyte of a cell performing in wide temperature ranges.

Unfortunately, the advantages of PC cannot be used in Li-ion cells with a highly crystalline graphite anode due to incompatibility between PC and graphite. Highly crystalline graphite is widely available and has higher actual energy density than amorphous carbon and is therefore a desirable anode material in Li-ion cells. However, PC molecules co-intercalate along with Li ions into the carbonaceous anode materials and decompose between graphite layers or on the surface of the carbonaceous anode, which subsequently exfoliates the carbonaceous anode and generates gases inside the batteries. These problems not only shorten the life and performance of the batteries, but also raise safety concerns because of a build-up of internal pressure. This problem may be resolved by using EC as the main solvent in the electrolyte. However, EC has a high melting point of 38° C. and tends to freeze at low temperatures. Thus, there is a continuing need for an electrochemical system that allows a user to retain the benefits of a lithium-ion cell operating in wide temperature ranges.

Another problematic aspect of lithium ion cells is “first cycle irreversible capacity” which occurs when an electrical potential is initially applied to Li-ion cells constructed with a carbonaceous material as anode (or negative electrode) in the charge process. To avoid lithium metal deposit on the anode, Li-ion cells are generally designed to be cathode limited. Since all of the lithium ions, which shuttle between the anode and the cathode during charging and discharging, originally come from the lithiated cathode, the larger the first cycle irreversible capacity, the lower the cell capacity in subsequent cycles. First cycle irreversible capacity is permanent capacity loss that occurs due to the anode surface film formation. Such films are also known as the solid-electrolyte interphase (SEI). The formation of a surface film is very common for alkali metal systems, and in particular, lithium metal anodes and lithium intercalated carbon anodes due to their low potential and high reactivity of lithium toward organic electrolytes. The film formation process is highly dependent on the reactivity of the electrolyte components at the cell charging potentials. The electrochemical properties of the surface film are also dependent on the chemical composition of the film.

In order to avoid the problems inherent in such films, it would be advantageous to design an electrochemical system in which a surface film is electronically insulating and ionically conducting. While most alkali metals, and in particular, lithium electrochemical systems meet the first requirement, the second requirement is difficult to achieve. The resistance of these films is not negligible, and as a result, impedance builds up inside the cell due to the formation of this surface layer, which induces unacceptable polarization during the charge and discharge of the Li-ion cell. On the other hand, if the SEI film is electronically conductive, the electrolyte decomposition reaction on the anode surface does not stop due to the low potential of the lithiated carbon electrode.

The composition of the electrolyte has a significant influence on the cycling efficiency of alkali metal systems, and particularly the permanent capacity loss in secondary cells. For instance, Li-ion cells activated with the binary solvent electrolyte of ethylene carbonate and dimethyl carbonate cannot be cycled at temperatures lower than about −11° C. Cells with graphite as anode, activated with the binary solvent electrolyte of propylene carbonate and ethylene carbonate cannot be cycled at all due to the decomposition of PC. The PC-based electrolyte is a compromise in terms of providing a wider temperature application with acceptable cycling efficiencies.

Thus, it would be highly desirable to have an electrochemical system that allows retention of the benefits of a lithium ion cell capable of operating in wide temperature ranges while minimizing the first cycle irreversible capacity.

### SUMMARY OF THE INVENTION

An electrochemical system is provided by the present invention which includes a positive electrode; a negative electrode; an electrolyte containing a lithium salt dissolved in a non-aqueous solvent; and a nitrile component in the electrolyte. The nitrile component is present in amounts ranging from 0.01-25 weight percent, 0.05-15 weight percent or 0.1-10 weight percent. The non-aqueous solvent optionally includes an organic ester, an organic ether, a cyclic ester and a mixture thereof.

A nitrile component of a provided electrolyte has the formula:

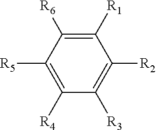

wherein R₁, R₂, R₃, R₄, R₅ and R₆ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₇ linear or branched, substituted or unsubstituted alkyl, alkoxy, alkenyl, heteroalkyl, or heteroalkenyl moiety having a pendant nitrile moiety. Optionally, the C₁-C₇ linear or branched, alkyl, alkoxy, alkenyl, heteroalkyl, or heteroalkenyl moiety includes a halogen.

Further optionally, R₁, R₂, R₃, R₄, R₅ and R₆ are each independently: H; a halogen; a nitrile moiety; an isocyanate moiety; an ether moiety; a halogen substituted ether moiety; an ester moiety; a halogen substituted ester moiety; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₃ linear or branched, substituted or unsubstituted alkyl, alkoxy, alkenyl, heteroalkyl, or heteroalkenyl moiety having a pendant nitrile moiety. In another option, the C₁-C₃ linear or branched, alkyl, alkoxy, alkenyl, heteroalkyl, or heteroalkenyl moiety includes a halogen.

Also provided is an electrochemical system in which the nitrile component has the formula:

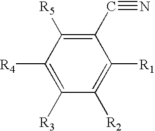

wherein R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof. Optionally, the C₁-C₇ linear or branched, alkyl, alkoxy, alkenyl, heteroalkyl, or heteroalkenyl moiety includes a halogen. In a further option, R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof. Also optionally, the C₁-C₃ linear or branched, alkyl, alkoxy, alkenyl, heteroalkyl, or heteroalkenyl moiety includes a halogen.

A nitrile component of an electrolyte provided in an inventive system includes 4-fluorobenzonitrile, 2-fluorobenzonitrile, 3-fluorobenzonitrile, 2,3-difluorobenzonitrile, 2,4-difluorobenzonitrile, 2,5-difluorobenzonitrile, 2,6-difluorobenzonitrile, 3,4-difluorobenzonitrile, 3,5-difluorobenzonitrile and a mixture thereof.

Further provided is an electrolyte composition which includes a non-aqueous solvent, an inorganic salt and a nitrile component. In a preferred option, the inorganic salt is a lithium salt.

Also provided is a process for inhibiting electrolyte decomposition wherein an initial cycle is performed on an electrochemical cell having an anode, the anode comprising a carbonaceous material, a cathode, and an electrolyte, the electrolyte comprising an inorganic salt, a non-aqueous solvent and a nitrile component such that a solid-electrolyte interphase forms on the anode, inhibiting electrolyte decomposition. In a preferred option, the inorganic salt is a lithium salt.

### BRIEF DESCRIPTION OF THE DRAWINGS

FIG. 1 is a graph illustrating aspects of electrolyte stability in an inventive electrochemical cell.

FIG. 2 is a graph illustrating aspects of cycling performance of the first two cycles in inventive electrochemical cells.

FIG. 3 is a graph illustrating aspects of cycling performance of the initial two cycles in an inventive electrochemical cell.

FIG. 4 is a graph illustrating aspects of cycling performance in inventive electrochemical cells.

FIG. 5 is a graph illustrating aspects of cycling performance of the first cycle in inventive electrochemical cells.

FIG. 6 is a graph illustrating aspects of cycling performance of the initial two cycles in an inventive electrochemical cell.

FIG. 7 is a graph illustrating aspects of cycling performance in inventive electrochemical cells.

FIG. 8 is a graph illustrating aspects of electrolyte stability in inventive electrochemical cells.

### DESCRIPTION OF THE PREFERRED EMBODIMENTS

An electrochemical system according to the present invention operates in wide temperature ranges while minimizing the first cycle irreversible capacity.

An electrochemical system of the present invention includes a negative electrode, a positive electrode and a non-aqueous electrolyte containing a nitrile compound.

The terms “positive electrode” and “cathode” are used interchangeably herein as are the terms “negative electrode” and “anode.” This terminology reflects the fact that during discharge of an electrochemical system, lithium ions from the negative electrode move through the electrolyte to the positive electrode, where the ions are incorporated. Thus, during discharge, the positive electrode functions as a cathode, and the negative electrode as an anode. During charge of a secondary electrochemical cell, lithium ions flow from the positive electrode through the electrolyte and back to the negative electrode.

Preferably an inventive electrochemical cell includes an anode, or negative electrode, comprising a material in which an alkali metal ion, preferably lithium ion, intercalates and de-intercalates. A preferred anode comprises a carbonaceous material. A carbonaceous material includes any of the various forms of carbon illustratively including coke, graphite, acetylene black, carbon black, and glassy carbon, which are capable of reversibly retaining a lithium species. Graphite is particularly preferred due to its relatively high lithium-retention capacity.

The cathode, or the positive electrode, of an electrochemical system preferably includes an air-stable lithiated material that is stable in air and readily handled. Examples of such lithiated cathode materials include compounds such as halides, oxides, sulfides, selenides, and tellurides of metals as including chromium, cobalt, copper, iron, manganese, molybdenum, nickel, niobium, titanium, and vanadium. Particularly preferred oxides include LiNiO₂, LiMn₂O₄, LiCoO₂ and the like.

An electrolyte solvent system for activating an electrochemical cell, and particularly a lithium-ion cell, is selected which is compatible with the high potential of the cathode material (up to 4.3V vs. Li/Li⁺) and the low potential of the anode material (down to 0.01V vs. Li/Li⁺). According to the present invention, a non-aqueous electrolyte includes an inorganic salt, a non-aqueous solvent and a nitrile component.

A non-aqueous electrolyte according to the invention includes a non-aqueous solvent that has high oxidative stability toward the cathode material and good kinetic stability toward the anode material. In a preferred embodiment, a non-aqueous solvent includes an oxygen-containing organic compound and a lithium salt.

Exemplary preferred oxygen-containing organic compound solvents include linear or cyclic esters and linear or cyclic ethers. Organic esters exhibit high oxidative stability toward cathode materials and good kinetic stability toward anode materials. Illustrative organic ester compounds include linear ester compounds such as: dimethyl carbonate (DMC), diethyl carbonate (DEC), dipropyl carbonate (DPC), ethylmethyl carbonate (EMC), methylpropyl carbonate (MPC), ethylpropyl carbonate (EPC), methyl acetate, ethyl acetate, propyl acetate, isopropyl acetate, butyl acetate, methyl propionate, ethyl propionate, propyl propionate, isopropyl propionate, methyl butyrate, ethyl butyrate, propyl butyrate, isopropyl butyrate and mixtures thereof. Illustrative organic ester compounds further include cyclic ester compounds illustratively including propylene carbonate (PC), ethylene carbonate (EC), butylene carbonate (BC), vinylene carbonate (VC), γ-butyrolactone (γ-BL) and mixtures thereof.

Optionally, the non-aqueous solvent includes more than one cyclic ester compound. In a preferred embodiment, where the non-aqueous solvent includes a first cyclic ester compound and a second cyclic ester compound, the first cyclic ester compound and the second cyclic ester compound are present in a ratio ranging from 1:20-20:1. Further preferably, the first cyclic ester compound and the second cyclic ester compound are present in a ratio ranging from 1:5-5:1. In another preferred embodiment the first cyclic ester compound and the second cyclic ester compound are present in a ratio ranging from 1:2-2:1 and further preferably in a ratio of 1:1.

Optionally, a non-aqueous electrolyte includes a linear ester compound and a cyclic ester compound. In a preferred embodiment, where the non-aqueous solvent includes a linear ester compound and a cyclic ester compound, the linear ester compound and the cyclic ester compound are present in a ratio ranging from 1:20-20:1. Further preferably, the linear ester compound and the cyclic ester compound are present in a ratio ranging from 1:5-5:1. In another preferred embodiment the linear ester compound and the cyclic ester compound are present in a ratio ranging from 1:2-2:1 and further preferably in a ratio of 1:1.

In a further option, the non-aqueous solvent includes a first cyclic ester compound, a second cyclic ester compound and a linear ester compound. In such an embodiment, the cyclic ester compounds and the linear ester compound are present in a ratio ranging from 1:20-20:1. Further preferably, the cyclic ester compounds and the linear ester compound are present in a ratio ranging from 1:5-5:1. In another preferred embodiment the cyclic ester compounds and the linear ester compound are present in a ratio ranging from 2:3-3:2 and optionally, in a ratio of 1:1.

A preferred inorganic salt included in a non-aqueous electrolyte is a lithium salt. Illustrative examples of lithium salts include LiPF₆, LiBF₄, LiAsF₆, LiSbF₆, LiClO₄, LiAlCl₄, LiGaCl₄, LiC(SO₂CF₃)₃, LiN(SO₂CF₃)₂, LiSCN, CF₃CF₂SO₃Li, C₆F₅SO₃Li, LiO₂CCF₃, LiB(C₆H₅)₄, LiB(C₂O₄)₂, LiBF₂(C₂O₄), LiCF₃SO₃, and mixtures thereof. A lithium salt is typically present in concentrations ranging from 0.1 to 2.5 moles/liter of solvent. In some embodiments a lithium salt is included in concentrations ranging from 0.2 to 2.0 moles/liter of solvent. In some preferred embodiments a lithium salt is included in concentrations ranging from 0.3 to 1.5 moles/liter of solvent.

A nitrile component is included in a non-aqueous electrolyte according to the invention. A preferred nitrile component has the formula:

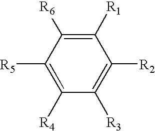

wherein R₁, R₂, R₃, R₄, R₅ and R₆ are each independently: H; a halogen; a nitrile moiety; an isocyanate moiety; an ether moiety such as methoxyl, ethoxyl, propoxyl and the like; a halogen substituted ether moiety; an ester moiety such as acetate, propionate, butyrate, isobutyrate and the like; a halogen substituted ester moiety such as trifluoroacetate, trichloroacetate, and the like; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₇ linear or branched, substituted or unsubstituted alkyl, alkoxy, alkenyl, heteroalkyl, or heteroalkenyl moiety having a pendant nitrile moiety.

Optionally, a C₁-C₇ linear or branched, alkyl, alkoxy, alkenyl, heteroalkyl, or heteroalkenyl moiety includes a halogen.

A preferred subset of nitrile compounds includes those wherein a nitrile component has the formula:

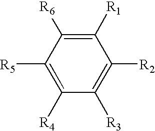

wherein R₁, R₂, R₃, R₄, R₅ and R₆ are each independently: H; a halogen; a nitrile moiety; an isocyanate moiety; an ether moiety such as methoxyl, ethoxyl, propoxyl and the like; a halogen substituted ether moiety; an ester moiety such as acetate, propionate, butyrate, isobutyrate and the like; a halogen substituted ester moiety such as trifluoroacetate, trichloroacetate, and the like; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₃ linear or branched, substituted or unsubstituted alkyl, alkoxy, alkenyl, heteroalkyl, or heteroalkenyl moiety having a pendant nitrile moiety.

Optionally, a C₁-C₃ linear or branched, alkyl, alkoxy, alkenyl, heteroalkyl, or heteroalkenyl moiety includes a halogen.

A further preferred nitrile component has the formula:

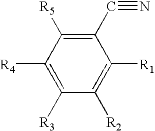

wherein R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof.

Optionally, a C₁-C₇ linear or branched, alkyl, alkoxy, alkenyl, heteroalkyl, or heteroalkenyl moiety includes a halogen.

A preferred subset of nitrile compounds includes those wherein a nitrile component has the formula:

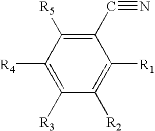

wherein R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof.

Optionally, a C₁-C₃ linear or branched, alkyl, alkoxy, alkenyl, heteroalkyl, or heteroalkenyl moiety includes a halogen.

A preferred nitrile component included in a non-aqueous electrolyte is a benzonitrile having a halogen moiety. A preferred halogen moiety is F. Further preferred halogen moieties include Cl, Br, and I. Particularly preferred are fluorobenzonitrile compounds, including 4-fluorobenzonitrile. Illustrative examples of further preferred benzonitrile compounds having a halogen moiety include 2-fluorobenzonitrile, 3-fluorobenzonitrile, 2,3-difluorobenzonitrile, 2,4-difluorobenzonitrile, 2,5-difluorobenzonitrile, 2,6-difluorobenzonitrile, 3,4-difluorobenzonitrile, and 3,5-difluorobenzonitrile.

Also preferred are benzonitrile compounds having an alkyl moiety, such as 2-methylbenzonitrile, 3-methylbenzonitrile, and 4-methylbenzonitrile.

Further preferred are benzonitrile compounds having an alkoxy moiety, such as 2-methoxybenzonitrile, 3-methoxybenzonitrile and 4-methoxybenzonitrile.

In addition, benzonitrile compounds having an isocyanate moiety are included as a nitrile component. Such compounds illustratively include 2-cyanophenyl isocyanate, 3-cyanophenyl isocyanate and 4-cyanophenyl isocyanate.

Also preferred are nitrile components having two or more nitrile groups. Such compounds illustratively include 1,2-dicyanobenzene, 1,3-dicyanobenzene, and 1,4-dicyanobenzene.

Typically, a nitrile component is present in a non-aqueous electrolyte at a concentration ranging from 0.01-25.0 weight percent. Preferably, a nitrile component is present in a non-aqueous electrolyte at a concentration ranging from 0.05-15.0 weight percent. Further preferably, a nitrile component is present in a non-aqueous electrolyte at a concentration ranging from 0.1-10.0 weight percent.

Optionally, more than one nitrile component is included in an inventive electrochemical system. In an embodiment including more than one nitrile component, the combined nitrile components are present at a concentration ranging from 0.01-25.0 weight percent. Preferably, a combination of nitrile components is present at a concentration ranging from 0.05-15.0 weight percent. Further preferably, a combination of nitrile components is present at a concentration ranging from 0.1-10.0 weight percent.

An electrochemical system according to the invention may incorporate elements typical of such systems as known in the art. For example, an electrochemical system may include a separator, a case or other such typical component. Further, an inventive electrochemical system may be provided in any of various configurations known in the art, such as wound, and the like.

### Processes for Inhibiting Decomposition of an Electrolyte Component

An inventive process for inhibiting decomposition of an electrolyte component of an electrochemical cell includes the step of forming a protective surface layer on an anode. Particularly preferred is the step of forming a protective surface layer on a carbonaceous anode. A protective layer is formed by providing an electrolyte for an electrochemical cell and performing an initial cycle, wherein the electrolyte includes an inorganic salt, a non-aqueous solvent and a nitrile component as described herein.

Although the exact reason for the observed improvement of an inventive cell containing a nitrile component over a cell containing no nitrile component is not clear, it is hypothesized that the nitrile additive competes with the existing electrolyte components to react on the carbon anode surface during initial lithiation to form a beneficial SEI film. The SEI film formed is electronically more insulating than the film formed without the nitrile additive and, as a consequence, the lithiated carbon electrode is better protected from reactions with other electrolyte components. Therefore, lower first cycle irreversible capacity is obtained.

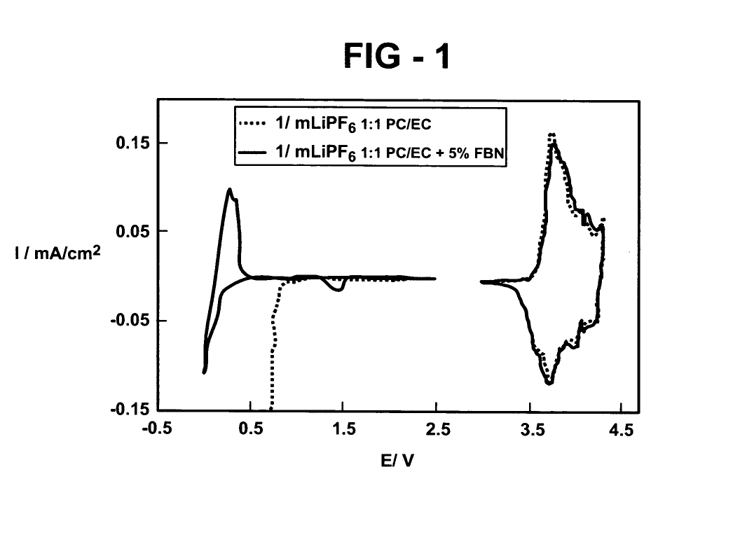

An electrochemical system according to the invention has more ionically conducting surface layer, or solid-electrolyte interphase (SEI). For instance, as shown in FIGS. 1, 2, 5, and 8, cells without a nitrile component additive cannot be cycled, while those with nitrile are able to cycle.

### EXAMPLES

### Example 1

Effect of a Nitrile Component, 4-Fluorobenzonitrile (FBN), on Electrolyte Stability in an Electrochemical Cell.

An electrolyte is prepared including 1 M LiPF₆ in a solvent of PC-EC wherein the PC:EC is present in a 1:1 weight ratio. Two identical lithium cells having a graphite electrode with an electrode area of 6 cm² are assembled, and two other identical lithium cells having a LiₓNi_{0.8}Co_{0.2}O₂ electrode with an electrode area of 6 cm² are assembled. One cell of each group is activated with the electrolyte having no nitrile component. A second cell of each group includes the electrolyte with 5 wt. % of FBN as a nitrile component.

Cyclic voltammetry tests are run on the four cells at 0.01 mV/s. FIG. 1 indicates that, with respect to the graphite electrode, the electrolyte without a nitrile component decomposes at ˜0.7 V. In contrast, the electrolyte containing 5% FBN shows a small reductive current peak at ˜1.4 V, which prevents PC from decomposition and ensures the reversible intercalation and de-intercalation cycle of lithium ions with graphite in the voltage range of <0.4 V. FIG. 1 also indicates that FBN has no adverse impact the oxidative stability of the electrolyte with respect to the LiₓNi_{0.8}Co_{0.2}O₂ electrode.

### Example 2

Cycling Performance of the First Cycle in a Graphite/LiₓNi_{0.8}Co_{0.2}O₂ Li-Ion Cell.

An electrolyte is prepared including 1 M LiPF₆ in a solvent of PC-EC, having a nitrile component, FBN, at a concentration of 0, 0.1, 0.5 or 2 weight percent. The electrolyte has a PC:EC weight ratio of 1:1.

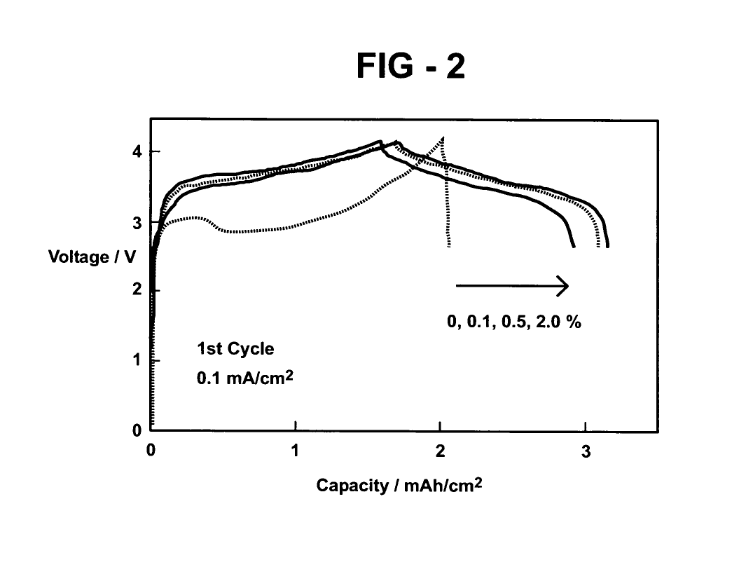

Four identical graphite/LiₓNi_{0.8}Co_{0.2}O₂ button cells with an anode/cathode area ratio of 1.27 cm² to 0.97 cm² are assembled and a different electrolyte is included in each in order to compare performance. The cells are cycled at 0.1 mA/cm² between 4.2 V and 2.7 V. FIG. 2 shows that the cell without the nitrile component cannot be cycled and presents no discharge capacity, while those containing 0.1 to 2.0 wt. % FBN show normal charge and discharge cycle.

### Example 3

Cycling Performance of the Initial Two Cycles for a Li-Ion Cell Using an Electrolyte Including a Nitrile Component.

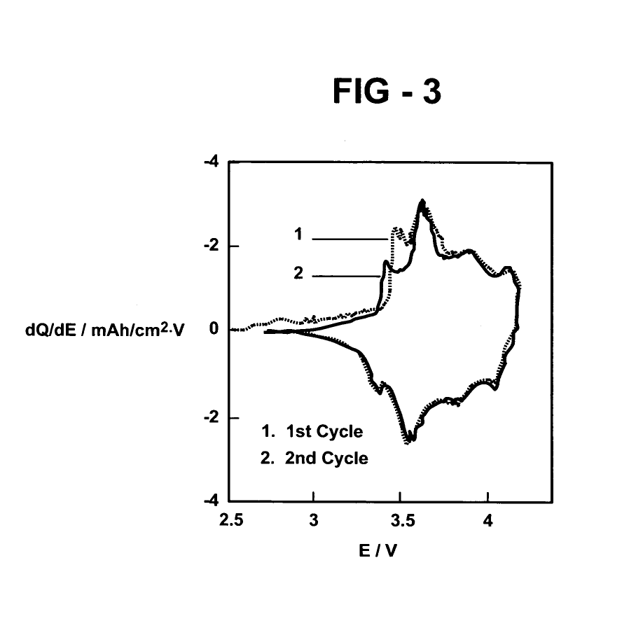

A Li-ion cell as described in Example 2 is prepared in which the electrolyte includes 0.1 wt. % FBN. The cell is cycled at 0.1 mA/cm² between 4.2 and 2.7 V. FIG. 3 indicates that there exist additional irreversible capacities below 3.6 in the first cycle. These irreversible capacities result in the formation of SEI and enable the cell to be cycled, while the cell without the addition of FBN cannot be cycled.

### Example 4

Cycling Performance of Li-Ion Cells Using an Electrolyte with Various Concentrations of a Nitrile Component.

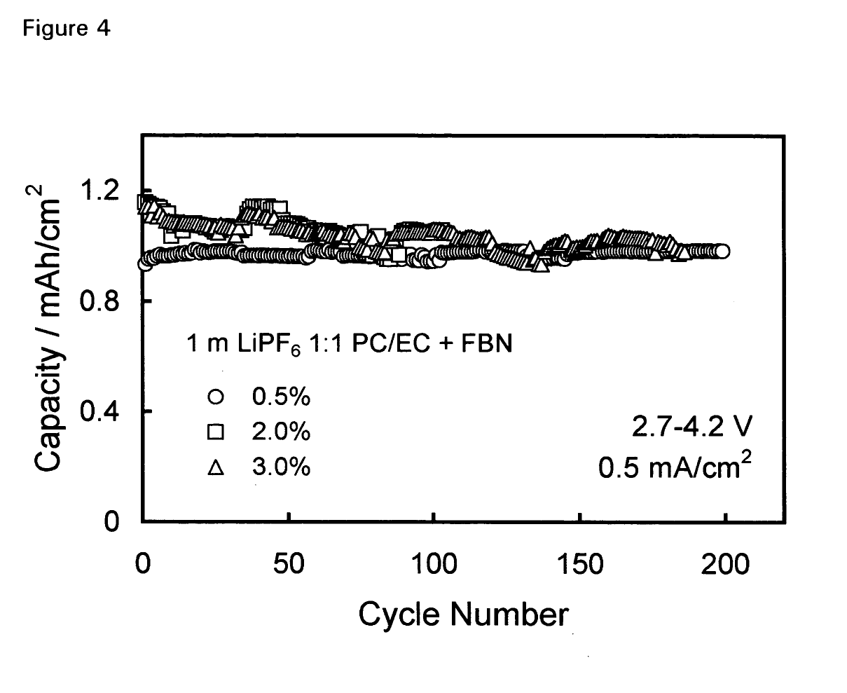

Electrochemical cells as described in Example 2 are prepared which include 0, 0.5, 2.0 or 3.0 weight percent of FBN. The cells are cycled at 0.5 mA/cm² between 2.7 V and 4.2 V. FIG. 4 indicates that the cells containing a nitrile component can be cycled with good capacity retention. The control cell, which contains no FBN, cannot be cycled.

### Example 5

Cycling Performance of the First Cycle of Li-Ion Cells Using an Electrolyte Including Various Concentrations of a Nitrile Component.

An electrolyte is prepared including 1 M LiPF₆ in a solvent of PC-EC-EMC, having a nitrile component, FBN, at a concentration of 0, 0.25 or 1 weight percent. The electrolyte has a PC:EC:EMC weight ratio of 1:1:3.

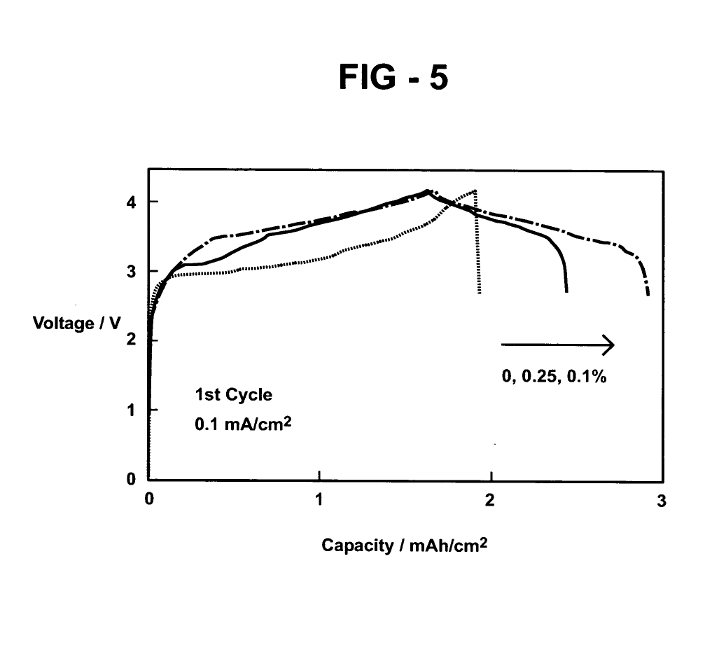

Three identical graphite/LiₓNi_{0.8}Co_{0.2}O₂ button cells with an anode/cathode area ratio of 1.27 cm² to 0.97 cm² are assembled and a different electrolyte is included in each in order to compare performance. Note that in this example the graphite electrode includes highly crystalline graphite, which has a much stronger ability to decompose PC. The highly crystalline graphite is included as an anode. The cells are assembled and cycled at 0.1 mA/cm² between 2.7 V and 4.2 V. A voltage-capacity curve of the first cycle is depicted in FIG. 5. The voltage-capacity curve indicates that the cell cannot be cycled in the absence of FBN. With FBN added to the electrolyte, the cells become able to perform and their irreversibility decreased with increasing of the FBN content.

### Example 6

Cycling Performance of the First Cycle of Li-Ion Cells Using an Electrolyte Including Various Concentrations of a Nitrile Component.

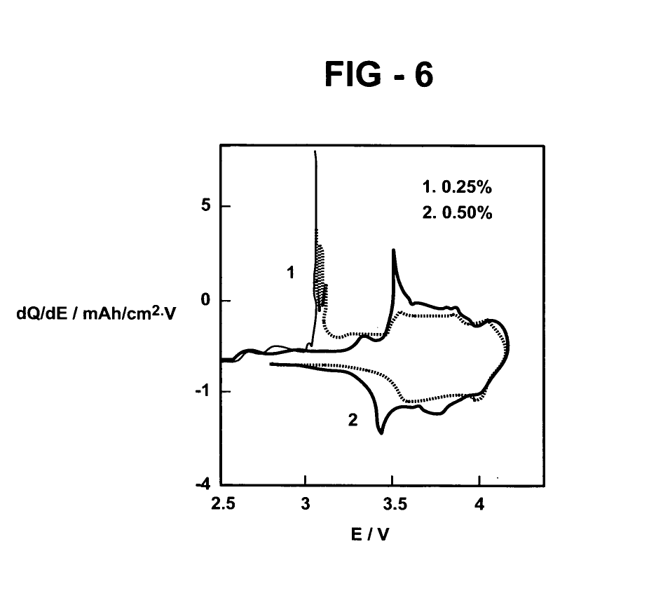

Two cells as described in Example 5 are cycled at 0.1 mA/cm² between 2.7 V and 4.2 V. FIG. 6 illustrates differences in cycling performance of the first cycle in cells including 0.25% or 0.5% FBN in the electrolyte. It can be seen that at ˜3.1 V there still exists an irreversible differential capacity peak, which is known to arise from solvent decomposition, in the presence of 0.25% FBN. However, the solvent decomposition is effectively suppressed as the content of FBN reaches 0.5%.

### Example 7

Cycling Performance of Li-Ion Cells Using an Electrolyte Including Various Concentrations of a Nitrile Component.

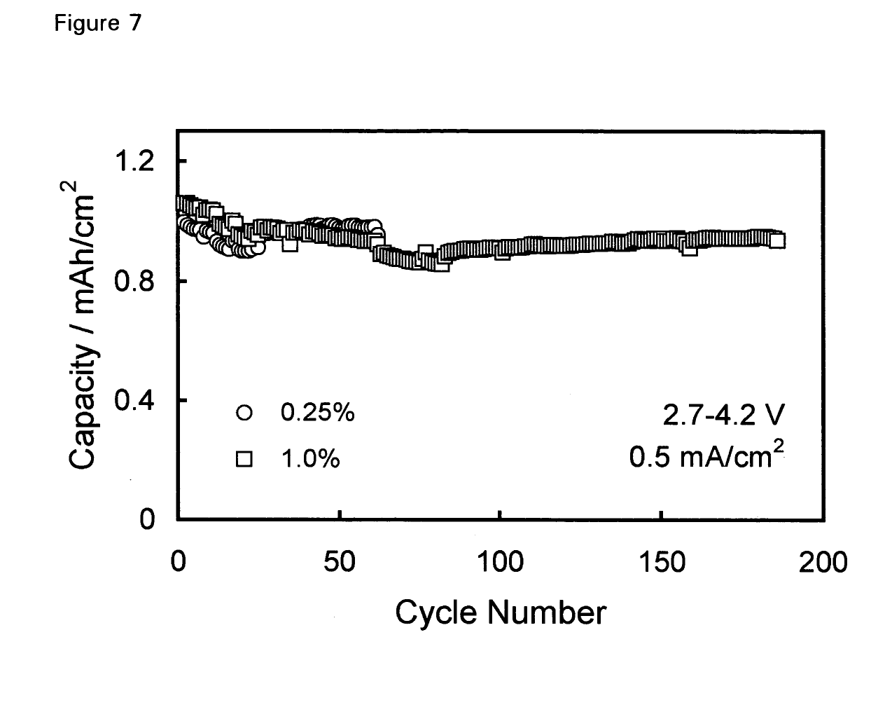

Cells as described in Example 6 are assembled including 0.25% or 1.0% FBN in the electrolyte. The cells are cycled at 0.5 mA/cm² between 2.7 V and 4.2 V. FIG. 7 illustrates that these two cells can be cycled with good capacity retention. While the control cell, which contains no FBN, cannot be cycled (not shown).

### Example 8

Effect of a Nitrile Component, 4-Fluorobenzonitrile (FBN), on Electrolyte Stability in an Electrochemical Cell.

An electrolyte is prepared including 1 M LiPF₆ in a solvent of PC-EC-EMC wherein the PC:EC:EMC is present in a 3:3:4 weight ratio. Two identical electrochemical cells having a graphite electrode and a LiₓNi_{0.8}Co_{0.2}O₂ electrode with an electrode area of 6 cm² are assembled. One electrochemical cell is activated with the electrolyte having no nitrile component. A second electrochemical cell includes the electrolyte with 5 weight % of FBN as a nitrile component. Except for the electrolyte, the cells are the same.

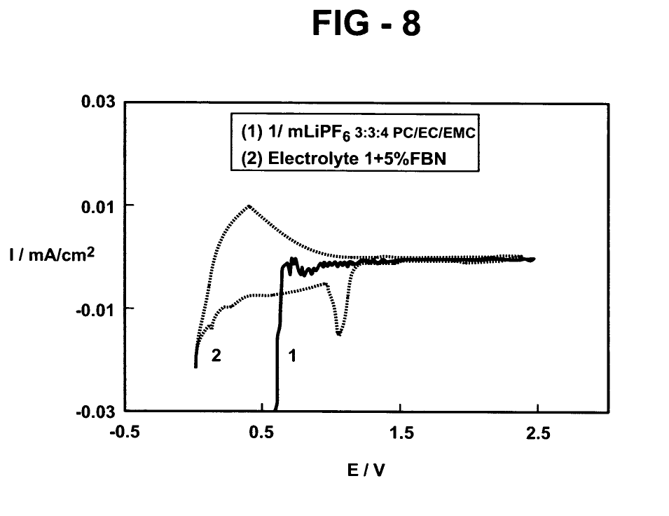

The two cells are scanned at 0.1 mV/s. FIG. 8 shows a cyclic voltammogram of the first cycle of these two cells. It can be seen that, without FBN, the electrolyte is strongly decomposed at 0.6-0.7 V. When 5 wt. % FBN is added to the electrolyte, however, a reductive current peak is present at about 1.0 V, which effectively suppresses the solvent decomposition and enables the cell to perform.

### Example 9

Electrolyte stability and cycling tests are performed as in Examples 1-8 using electrochemical cells in which various nitrile components having the general formula:

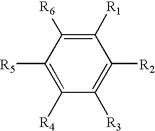

wherein R₁, R₂, R₃, R₄, R₅ and R₆ are each independently: H; a halogen; a nitrile moiety; an isocyanate moiety; an ether moiety; an ester moiety; or a C₁-C₅ linear or branched, substituted or unsubstituted alkyl, alkoxy, alkenyl, heteroalkyl, or heteroalkenyl moiety, wherein the C₁-C₅ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₅ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C1-C₅ linear or branched, substituted or unsubstituted alkyl, alkoxy, alkenyl, heteroalkyl, or heteroalkenyl moiety having a pendant nitrile moiety. Results similar to those described in Examples 1-8 are obtained.

Any patents or publications mentioned in this specification are indicative of the levels of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The apparatus and processes described herein are presently representative of preferred embodiments, exemplary, and not intended as limitations on the scope of the invention. Changes therein and other uses will occur to those skilled in the art. Such changes and other uses are encompassed within the spirit of the invention as defined by the scope of the claims.

1. An electrochemical system, comprising:
a positive electrode;
a negative electrode;
an electrolyte comprising a lithium salt dissolved in a non-aqueous solvent; and
a nitrile component present in amounts ranging from 0.1-3 weight percent of the electrolyte, inclusive, as an additive to the electrolyte.

2. (canceled)

3. (canceled)

4. (canceled)

5. The electrochemical system of claim 1 wherein the non-aqueous solvent comprises an organic ester.

6. The electrochemical system of claim 1 wherein the non-aqueous solvent comprises an organic ether.

7. The electrochemical system of claim 1 wherein the non-aqueous solvent comprises a cyclic ester.

8. The electrochemical system of claim 1 wherein the nitrile component has the formula: 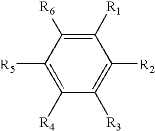
wherein R₁, R₂, R₃, R₄, R₅ and R₆ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₇ linear or branched, substituted or unsubstituted alkyl, alkoxy, alkenyl, heteroalkyl, or heteroalkenyl moiety having a pendant nitrile moiety.

9. The electrochemical system of claim 8 wherein the C₁-C₇ linear or branched, alkyl, alkoxy, alkenyl, heteroalkyl, or heteroalkenyl moiety comprises a halogen.

10. The electrochemical system of claim 8 wherein R₁, R₂, R₃, R₄, R₅ and R₆ are each independently: H; a halogen; a nitrile moiety; an isocyanate moiety; an ether moiety; a halogen substituted ether moiety; an ester moiety; a halogen substituted ester moiety; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₃ linear or branched, substituted or unsubstituted alkyl, alkoxy, alkenyl, heteroalkyl, or heteroalkenyl moiety having a pendant nitrile moiety.

11. The electrochemical system of claim 10 wherein the C₁-C₃ linear or branched, alkyl, alkoxy, alkenyl, heteroalkyl, or heteroalkenyl moiety comprises a halogen.

12. The electrochemical system of claim 1 wherein the nitrile component has the formula: 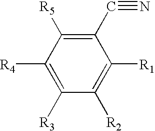
wherein R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof.

13. The electrochemical system of claim 12 wherein the C₁-C₇ linear or branched, alkyl, alkoxy, alkenyl, heteroalkyl, or heteroalkenyl moiety comprises a halogen.

14. The electrochemical system of claim 12 wherein R₁, R₂, R₃, R₄ and R₅ are each independently: H; a halogen; a nitrile moiety; an isocyanate moiety; an ether moiety; a halogen substituted ether moiety; an ester moiety; a halogen substituted ester moiety; or a C₁-C₃ linear or branched, substituted or unsubstituted alkyl, alkoxy, alkenyl, heteroalkyl, or heteroalkenyl moiety, wherein the C₁-C₃ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₃ linear or branched, substituted or unsubstituted alkyl, alkoxy, alkenyl, heteroalkyl, or heteroalkenyl moiety; and a combination thereof.

15. The electrochemical system of claim 14 wherein the C₁-C₃ linear or branched, alkyl, alkoxy, alkenyl, heteroalkyl, or heteroalkenyl moiety comprises a halogen.

16. The electrochemical system of claim 1 wherein the nitrile component is 4-fluorobenzonitrile.

17. The electrochemical system of claim 1 wherein the nitrile component is selected from the group consisting of: 4-fluorobenzonitrile, 2-fluorobenzonitrile, 3-fluorobenzonitrile, 2,3-difluorobenzonitrile, 2,4-difluorobenzonitrile, 2,5-difluorobenzonitrile, 2,6-difluorobenzonitrile, 3,4-difluorobenzonitrile, 3,5-difluorobenzonitrile and a mixture thereof.

18. The electrochemical system of claim 1 wherein the non-aqueous solvent comprises a first cyclic ester compound and a second cyclic ester compound.

19. (canceled)

20. The electrochemical system of claim 18 further comprising a linear ester compound.

21. The electrochemical system of claim 1 wherein the anode comprises a carbonaceous material.

22. The electrochemical system of claim 1 wherein the anode comprises graphite.

23. An electrolyte composition, comprising:
a non-aqueous solvent;
an inorganic salt; and
a nitrile component present in amounts ranging from 0.1-3 weight percent, inclusive.

24. The electrolyte composition of claim 23 wherein the nitrile component has the formula: 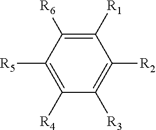
wherein R₁, R₂, R₃, R₄, R₅ and R₆ are each independently: H; a halogen; a nitrile moiety; an isocyanate moiety; an ether moiety; a halogen substituted ether moiety; an ester moiety; a halogen substituted ester moiety; or a C₁-C₇ linear or branched, substituted or unsubstituted alkyl, alkoxy, alkenyl, heteroalkyl, or heteroalkenyl moiety, wherein the C₁-C₇ linear or branched, substituted or unsubstituted alkyl, alkoxy, alkenyl, heteroalkyl, or heteroalkenyl moiety optionally has a pendant group selected from: a halogen, a nitrile moiety, an isocyanate moiety, an ether moiety, an ester moiety, a C₁-C₇ linear or branched, substituted or unsubstituted alkyl, alkoxy, alkenyl, heteroalkyl, or heteroalkenyl moiety; and a combination thereof; and wherein at least one of R₁, R₂, R₃, R₄, R₅ and R₆ is a nitrile moiety or a C₁-C₇ linear or branched, substituted or unsubstituted alkyl, alkoxy, alkenyl, heteroalkyl, or heteroalkenyl moiety having a pendant nitrile moiety.

25. The electrolyte of claim 24 wherein the C₁-C₇ linear or branched, alkyl, alkoxy, alkenyl, heteroalkyl, or heteroalkenyl moiety comprises a halogen.

26. The electrolyte of claim 23 wherein the inorganic salt is a lithium salt.

27. (canceled)

28. (canceled)

29. (canceled)

30. (canceled)
